(19) United States
(12) Patent Application Publication
(10) Pub. No.: US 2011/0046017 A1
(43) Pub. Date: Feb. 24, 2011

(54) MOLD OF RECIPIENT BLOCK AND USAGE THEREOF

(76) Inventor: Seung Min Song, Seoul (KR)

Correspondence Address: SWANSON & BRATSCHUN, L.L.C., 8210 SOUTHPARK TERRACE, LITTLETON, CO, 80120, US

(21) Appl. No.: 12/518,042

(22) PCT Filed: Nov. 30, 2007
(86) PCT No.: PCT/KR2007/006144

§ 371 Date: Nov. 9, 2010

(30) Foreign Application Priority Data
Dec. 6, 2006 (KR) 10-2006-0122843

(51) Int. Cl. C40B 50/00; B29C 39/26

(52) U.S. Cl. 506/23; 425/352

(57) ABSTRACT

Disclosed are a mold for the preparation of recipient blocks, having a certain space at the top and containing multiple sample-receiving holes in the bottom thereof and a method for preparing a tissue microarray block, comprising: (1) arraying samples in the sample-receiving holes in the mold for the preparation of recipient blocks; (2) placing the mold for the preparation of recipient blocks in a base mold and pushing the samples toward the bottom of the base mold; (3) filling the base mold with a liquid base material for the recipient block and incubating the liquid base material at a predetermined temperature for a predetermined time period; and (4) separating the tissue microarray block from the mold for the preparation of recipient blocks, said tissue microarray block being formed as the liquid base material is solidified so that the samples are embedded in a microarray pattern within the solidified material.

### TECHNICAL FIELD

The present invention relates to a mold for the preparation of recipient blocks and the use thereof. More particularly, the present invention relates to a mold for the preparation of recipient blocks, which has a certain space at the top and contains multiple sample-receiving holes in the bottom thereof. It also relates to a method for preparing a tissue microarray block comprising arraying samples in the sample-receiving holes, placing the mold in a base mold, filling the base mold with a liquid base material for the recipient block, and separating the tissue microarray block from the mold as the liquid base material is solidified.

### BACKGROUND ART

A tissue microarray is an ordered array of numerous (30˜120) separate tissue samples, attached onto a single glass slide, typically 2.5×7.5 cm in size, and the term also indicates technology for preparing the above tissue array. Biological tissues useful in the tissue microarray include human tissues, animal tissues and cultured cells. A glass slide, onto which tissue microarray samples are attached, is useful for microscopic analysis such as the analysis of intracellular proteins, DNA and RNA. The tissue microarray can be applied for a broad range of in situ assays, for examples, in situ PCR, special staining, in situ hybridization, immunohistochemistry, etc.

In the early days of medical and biological fields, one glass slide was used for only one tissue sample because such samples were bigger than 1×2×0.4 cm in size. Thus, especially when it was desired to analyze multiple tissue samples, this conventional method was disadvantageous in that it required as many slides as the number of samples, as well as large quantities of disposable materials and reagents, resulting in time consuming and high cost analysis of the tissue samples. Further disadvantages with the conventional method are lack of consistency and reliability, since the tissue samples to be compared with each other are analyzed separately and individually.

The tissue microarray technique has been developed to overcome these problems. In the tissue microarray technique, a hollow needle is used to remove tissue cores from regions of interest in paraffin-embedded tissues such as clinical biopsies or tumor samples. These tissue cores are then inserted in a recipient paraffin block in a precisely spaced array pattern. Sections from this block are cut using a microtome, mounted on a microscope slide and then analyzed by any method of standard histological analysis. Tissue microarray technologies are described in the following prior arts.

International Patent Application No. PCT/DE00/04647 discloses a method of preparing a recipient block capable of receiving multiple tissue samples. In detail, the method of preparing a recipient block comprises punching holes in the bottom of a tray-type aluminium block and striking a cylindrical pin into each hole to form a template for the recipient block; pouring a molten, high-temperature paraffin solution into the template; and cooling the template to provide multiple cylindrical holes.

U.S. Pat. Unexamined Publication No. 2005/0260740 discloses a manual tissue micro-array (TMA) building set, which includes a TMA block mold, made from iron, for preparing a recipient block. Molten paraffin is poured into the block mold and then the mold is covered with a cassette. After cooling the paraffin until it is solidified, the recipient block is separated from the mold by being slowly lifted upwards by means of threaded arms provided on both sides of the mold.

In the prior art, as mentioned above, tissue microarray blocks are manufactured through many process steps, including the preparation of a mold for recipient blocks, the preparation of recipient blocks using the mold, the arrangement of tissue samples in the cylindrical holes, and the embedment of the tissue sample in paraffin, which requires a long time period for the completion thereof.

### DISCLOSURE OF THE INVENTION

Leading to the present invention, intensive and thorough research on the preparation of tissue microarray blocks, conducted by the present inventors, resulted in the finding of a mold for the preparation of recipient blocks which has a certain space at the top and contains multiple sample-receiving holes in the bottom thereof. The present invention allows the preparation of recipient blocks with the concomitant implementation of arraying and embedding samples.

In accordance with an aspect thereof, the present invention provides a mold for the preparation of recipient blocks, having a certain space at the top and containing multiple sample-receiving holes in the bottom thereof.

In accordance with another aspect thereof, the present invention provides a method for preparing a tissue microarray block, comprising: (1) arraying samples in the sample-receiving holes in the mold for the preparation of recipient blocks; (2) placing the mold for the preparation of recipient blocks in a base mold and pushing the samples toward the bottom of the base mold; (3) filling the base mold with a liquid base material for the recipient block and incubating the liquid base material at a predetermined temperature for a predetermined time period; and (4) separating the tissue microarray block from the mold for the preparation of recipient blocks, as the liquid base material for recipient blocks is solidified.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows base molds and cassettes;

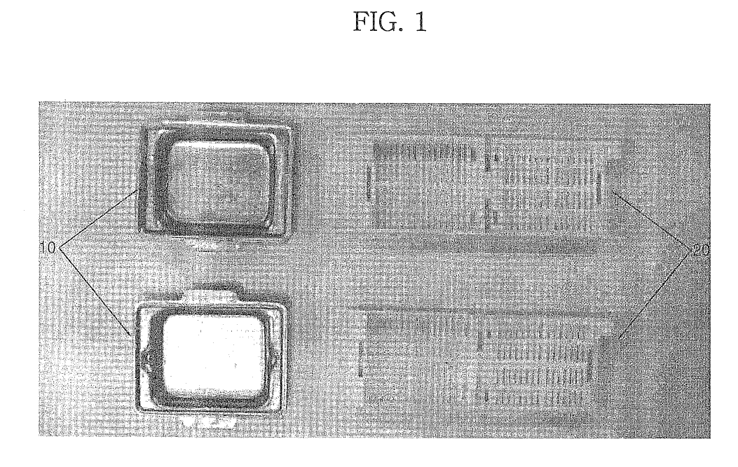

FIG. 2 shows conventional recipient blocks;

FIG. 3a is a perspective view showing a mold for the preparation of recipient blocks in accordance with an embodiment of the present invention;

FIG. 3b is a cross sectional view showing a mold for the preparation of recipient blocks in accordance with an embodiment of the present invention;

FIG. 4a is a perspective view showing a mold for the preparation of recipient blocks in accordance with another embodiment of the present invention;

FIG. 4b is a cross sectional view showing a mold for the preparation of recipient blocks in accordance with another embodiment of the present invention;

FIG. 5a is a photograph showing a process of arraying samples in cylindrical holes in the mold for the preparation of recipient blocks in accordance with the present invention;

FIG. 5b is a photograph showing a process of pushing the samples, confined within the cylindrical holes, toward the bottom of a base mold underneath the mold in accordance with the present invention;

FIG. 5c is a photograph showing a process of filling the base mold with a material for the recipient block in accordance with the present invention;

FIG. 5d is a photograph showing a process of incubating the material for the recipient block at a predetermined temperature for a predetermined time period in a paraffin oven in accordance with the present invention; and

FIG. 5e is a photograph showing a process of sectioning a tissue microarray block using a microtome in accordance with the present invention.

### DESCRIPTION OF NUMERALS FOR MAIN PARTS

10: Base mold
20: Cassette
30: Recipient block
31: Cylindrical hole
40: Mold for the preparation of recipient blocks
41: Cylindrical hole
42: Openings
50: Mold for the preparation of recipient blocks
51: Cylindrical holes projected
52: Spaces between grids

### BEST MODE FOR CARRYING OUT THE INVENTION

The present invention relates to a mold for the preparation of recipient blocks and a method of preparing recipient blocks using the same. First, a description will be given of a recipient block and various tools for use in preparing the recipient block. Then the mold for the preparation of recipient blocks in accordance with the present invention will be described in detail compared with the conventional mold for the preparation of recipient blocks.

The term “sample”, as used herein, refers not only to all tissue samples, isolated individually from humans, animals and plants, but also to culture products of microorganisms or cells. After they are taken from sample sources, generally, the samples for use in a tissue microarray are analyzed in association with a donor block rather than as they are. Thus, the term “sample” as used herein is intended to include a sample which is simply taken from a sample source, a sample treated with a donor block, and sections from the donor block-treated sample, particularly, sample cores.

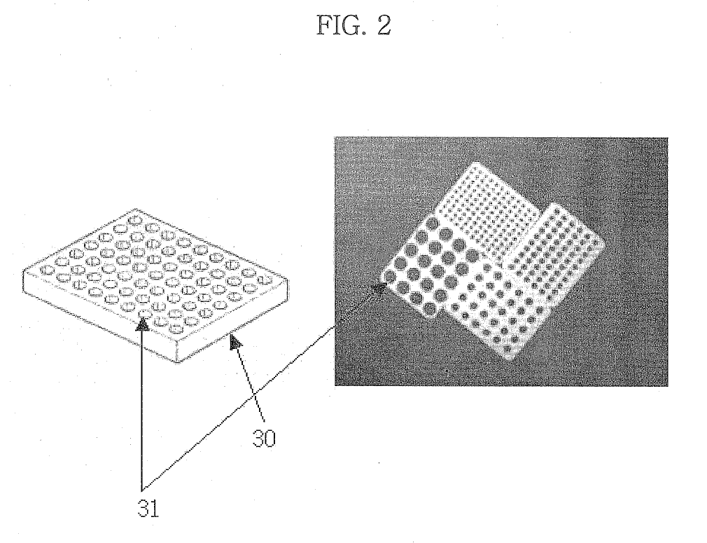

The term “base mold 10”, as used herein, is intended to refer to a tool for use in the preparation of recipient blocks and/or tissue microarray blocks. The base mold is typically made from metal and has a frame in a block shape (FIG. 2). Determining the contour of the recipient block, the frame of the base mold has a size and shape suitable to accommodate a mold for the preparation of recipient blocks according to the present invention.

The term “embedding”, as used herein, refers to a process of integrating tissue samples with the recipient block into a single structure by arraying the tissue samples in the cylindrical holes in the recipient block, heating the recipient block to melt the material comprising the recipient block and allow the molten wax to penetrate into and surround the tissue samples, and cooling the heated recipient block.

The term “cassette 20”, as used herein, is intended to refer to a tool which serves as a holder for supporting the recipient block when the solidified recipient block is lifted. That is, after molten paraffin (the material for recipient blocks) is poured into the base mold frame, the frame is covered with the cassette 20. While it solidifies, the paraffin becomes firmly attached to the cassette. A tissue microarray block is sectioned using a microtome, which is typically provided with a holder suitable for a cassette. Thus, the attachment of the recipient block to the cassette makes it easy to attach, detach and section the tissue microarray block by means of the microtome.

The term “tissue microarray block”, as used herein, indicates a product obtained through the embedding process, including arraying tissue samples into the cylindrical holes in the recipient block and heating and cooling the recipient block to fuse the tissue samples or donor blocks with the material comprising the recipient block.

The term “recipient block 30”, as used herein, is intended to refer to a tool serving as a mandrel for arraying corresponding tissue samples at predetermined positions on tissue microarray slides. The recipient block is typically in a rectangular parallelepiped form and has multiple cylindrical holes 31 for accommodating tissue samples. It is made mainly from paraffin.

Conventionally, a tissue microarray block is prepared through the steps of (a) manufacturing a recipient block; (b) arraying samples in cylindrical holes; (c) placing the sample-arrayed recipient block in the base mold and embedding it; and (d) sectioning the tissue microarray block using a microtome. In order to employ the microtome to section the tissue microarray block in step (d), the cassette is placed on the recipient block when it is embedded in step (c), with the aim of integrating the cassette with the recipient block. In other words, the cassette makes it easy to section the tissue microarray block with the microtome. In addition, the recipient block is disposable, because the entire tissue microarray block is sectioned with the microtome.

As used herein, the term “mold 40, 50 for the preparation of recipient blocks” is intended to refer to a tool having a structure corresponding to a desired recipient block. The mold 40, 50 for the preparation of recipient blocks contains multiple sample-receiving holes in the bottom thereof. In order to make the use of the base mold and the microtome convenient, all or part of the perimeter of the mold for the preparation of recipient blocks should be raised in a step-like formation. The sample-receiving holes may be formed as cylindrical holes in the bottom 41 or projected cylindrical holes 51 from the bottom.

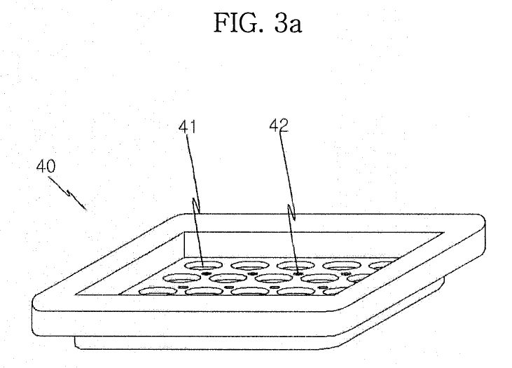

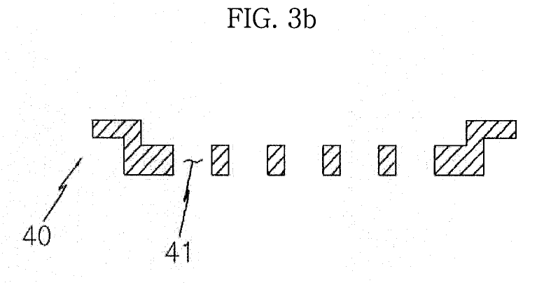

With reference to FIGS. 3a and 3b, a mold 40 for the preparation of recipient blocks in accordance with an embodiment of the present invention is shown in a perspective view and a cross sectional view, respectively. The mold 40, as shown in these figures, contains cylindrical holes 41 in the bottom, and is raised in a step-like formation around the entire perimeter thereof. It is preferred that the mold for the preparation of recipient blocks in accordance with this embodiment further contain openings 42 in the bottom. Since they serve as passages through which a molten material for recipient block moves upon the preparation of a tissue microarray block, as will be described later, the openings are not limited with regard to shape, diameter and number.

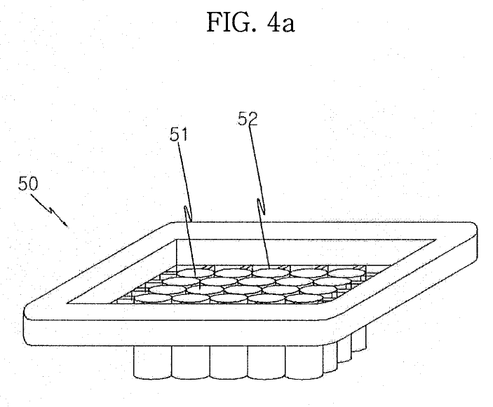

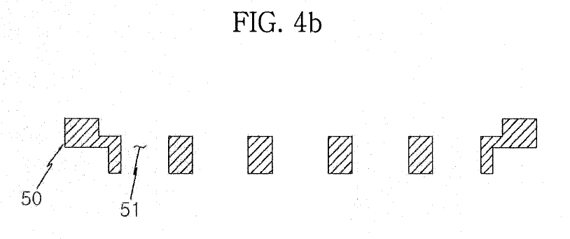

With reference to FIGS. 4a and 4b, a mold 50 for the preparation of recipient blocks in accordance with another embodiment of the present invention is shown in a perspective view and a cross sectional view, respectively. This mold contains cylindrical holes 51 respective rims of which project from the bottom, and is raised in a step-like formation around the entire perimeter thereof. The bottom of the mold for the preparation of recipient blocks in accordance with this embodiment is preferably compartmented in a grid pattern. The space 52 thus formed between the compartments may serve as a passage through which a molten material for the recipient blocks moves upon the preparation of the tissue microarray blocks, as will be described later.

Having the structural features described above, the mold for the preparation of recipient blocks may have a role as a cassette. The number of sample-receiving holes is determined by the number of samples to be analyzed. Even if it is not specifically limited, the inner diameter of the sample-receiving holes ranges from 1 to 5 mm, and preferably from 2 to 5 mm.

The mold for the preparation of recipient blocks may be made from a material selected from among, but not limited to, polyethylene, polyurethane, polyimide, polyethylene terephthalate, polymethylmethacrylate, polypropylene, polystyrene, polycarbonate, polyvinyl chloride, polyvinylidene chloride, polyvinyl acetate, polyvinyl alcohol, an acryl resin, a phenyl resin, a urea resin, a silicone resin, an epoxy resin, a melamine resin, polyester, polycarbonate, a fluorine resin, a cellulose resin, and an acetal resin.

The mold for the preparation of recipient blocks, although so named due to its use in the preparation of recipient blocks, is also used in arraying samples and embedding the samples and the recipient block material so as to prepare a tissue microarray block. Therefore, a method for preparing a tissue microarray block using the mold for the preparation of recipient blocks in accordance with the present invention constitutes one aspect of the present invention.

In accordance with the present invention, the method for preparing a tissue microarray block using the mold for the preparation of recipient blocks comprises (1) arraying samples in the sample-receiving holes in the mold for the preparation of recipient blocks; (2) placing the mold for the preparation of recipient blocks in a base mold and pushing the samples toward the bottom of the base mold; (3) filling the base mold with a liquid base material for the recipient block and incubating the liquid base material at a predetermined temperature for a predetermined time period; and (4) separating the tissue microarray block from the mold for the preparation of recipient blocks, when the liquid base material of the recipient block is solidified, so that the samples are embedded in a microarray pattern within the solidified material. Below, the method will be described stepwise in greater detail.

In step (1), samples are arrayed in the sample-receiving holes in the mold for the preparation of recipient blocks, for example, using a puncher. In this case, the puncher has a punching tip similar in diameter to the sample-receiving holes.

In step (2), the mold for the preparation of recipient blocks is placed in the base mold. Since both the mold for the preparation of recipient blocks and the base mold are of a tray type, the placement of the mold for the preparation of recipient blocks within the base mold looks like a two-story structure in which two trays are layered. Preferably, there is a gap between the sample-receiving holes in the mold for the preparation of recipient blocks and the bottom of the base mold, so that a space is formed. Later, this space is filled with a material for the recipient block.

Subsequently, the samples are pushed toward the bottom of the base mold using a stick. If a space is provided between the sample-receiving holes in the mold for the preparation of recipient blocks and the bottom of the base mold in this manner, or when a space is already formed in step (2), greater spaces can be further secured. At this time, as much of the samples as possible is moved to the space between the bottom of the sample-receiving holes in the mold for the preparation of recipient blocks and the bottom of the base mold, while as little of the samples as possible is allowed to remain within the sample-receiving holes.

In step (3), the base mold is filled with a liquid base material for the recipient block. Examples of the liquid base material for the recipient blocks include paraffin, microcrystalline wax, beeswax, agarose and agar, with preference for paraffin or a combination including paraffin. Since paraffin melts at 45˜60° C., heating at 60˜62° C. can transform paraffin from a solid to a liquid.

When the mold for the preparation of recipient blocks has any sample-receiving holes that are not filled with the samples, and/or any openings, the liquid base material for the recipient block migrates through the holes and/or the openings to the space formed between the sample-receiving holes in the mold for the preparation of recipient blocks and the bottom of the base mold. It is preferred that the liquid base material for the recipient block be filled sufficiently to immerse at least a part of the upper side of the mold for the preparation of recipient blocks therein. In this case, the mold for the preparation of recipient blocks is firmly attached to the tissue microarray block after the solidification of the liquid base material according to step (4), such that the tissue microarray block can be easily sectioned and treated.

After it is filled, the liquid base material for the recipient block is allowed to stand for a predetermined time period at a predetermined temperature in, for example, an oven. By doing so, the material for the recipient block can be fused to the sample or to a material for the donor block. Preferably, the paraffin is solidified at 45 to 60° C. for 10 to 60 min, and preferably for 20 to 30 min. Instead of the oven, a place or an instrument capable of maintaining a predetermined temperature may be used. Preferable is a paraffin oven.

In step (4), both the mold for the preparation of recipient blocks and the tissue microarray block attached thereto are separated from the base mold after the material for the recipient block is solidified.

Whereas conventional methods for preparing tissue microarray blocks using a recipient block require a separate process of preparing a recipient block, the present invention does not. Conventionally, samples are poured into the holes in the recipient block, which is then positioned within a base mold, followed by heating, embedding and cassette-attaching processes. However, the present invention is simpler and more convenient because the samples are arrayed and embedded during the formation of a recipient block. Further, the mold for the preparation of recipient blocks, which also serves as a cassette, obviates separate processes associated with a conventional cassette.

A better understanding of the present invention may be obtained through the following example which is set forth to illustrate, but is not, to be construed as the limit of the present invention.

### Example

### Construction of Tissue Microarray Block

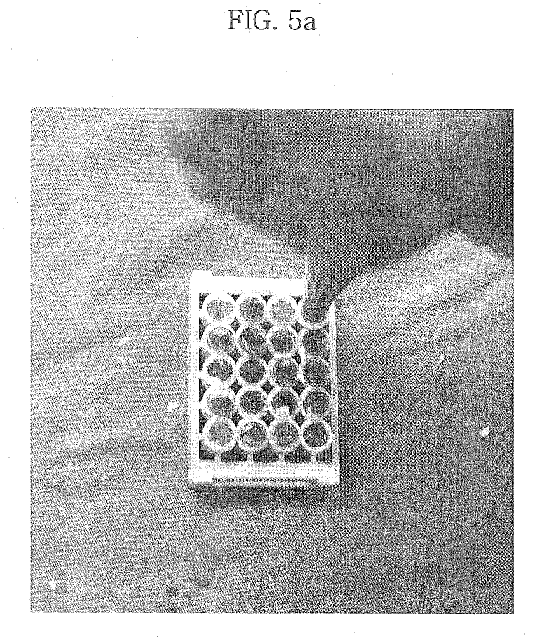

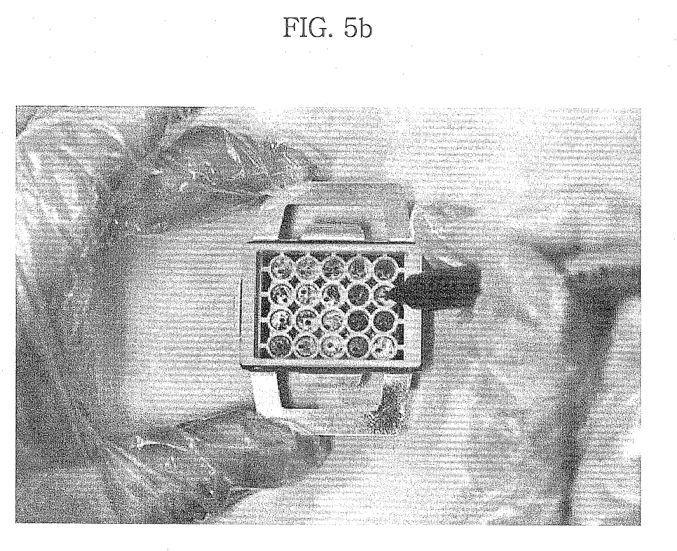

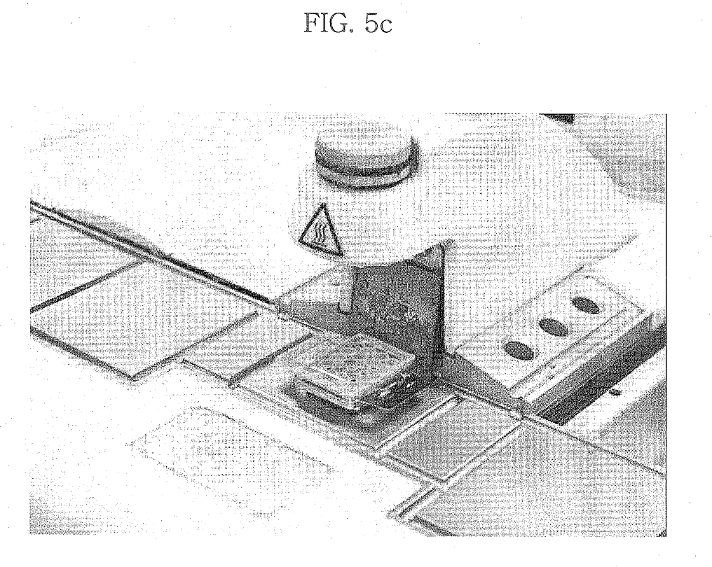

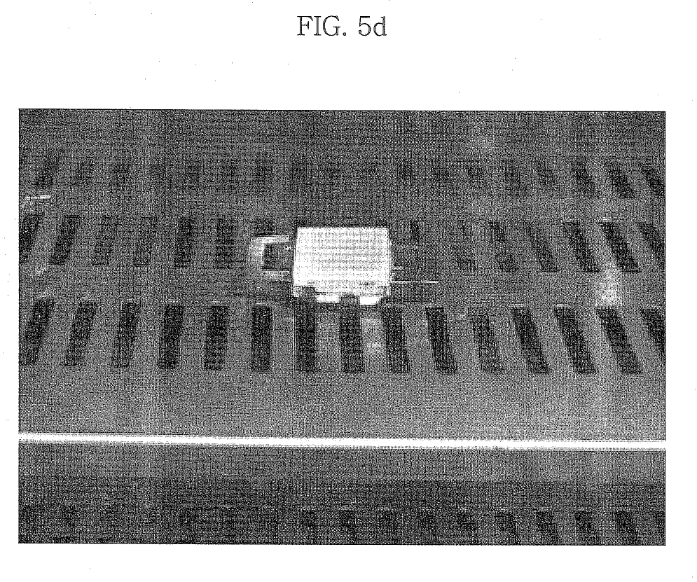

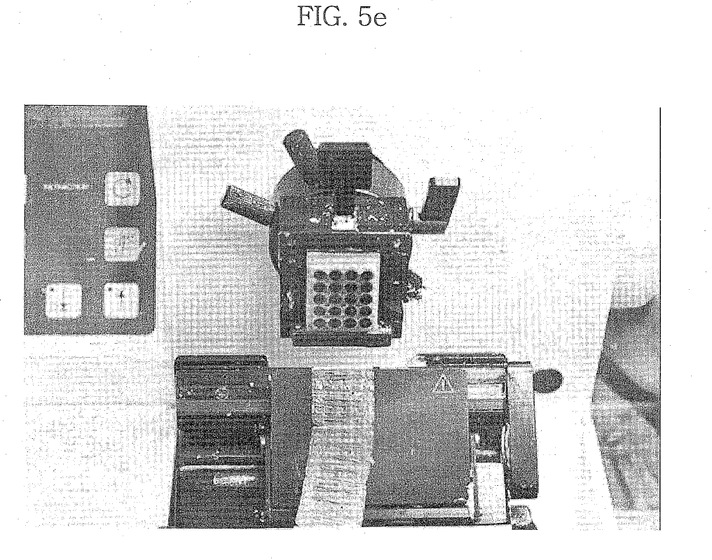

As illustrated in FIG. 5a, cores separated from a donor block were arrayed in the sample-receiving holes in the mold for the preparation of recipient blocks using puncher having a punching tip the diameter of which was to be the same as the inner diameter of the sample-receiving holes.

Next, the mold for the preparation of recipient blocks in accordance with the present invention was placed in the base mold, as shown in FIG. 5b. At this time, there should be some spacing between the sample-receiving holes in the mold for the preparation of recipient blocks and the bottom of the base mold. Subsequently, the samples were pushed toward the bottom of the base mold using a stick.

Thereafter, as shown in FIG. 5c, the base mold was filled with a liquid base material for the recipient block, followed by incubating it at 60˜62° C. for 20˜30 min in a paraffin oven, as shown in FIG. 5d. Then, the liquid base material was completely solidified on a cold plate, followed by the separation of a tissue microarray block from the base mold.

Using a microtome, as shown in FIG. 5e, the tissue microarray block was sectioned thinly, and the thin sections were placed on a glass slide under a microscope for histological assay.

### INDUSTRIAL APPLICABILITY

As described hitherto, the mold for the preparation of recipient blocks in accordance with the present invention allows the preparation of recipient blocks with the concomitant implementation of a procedure for arraying samples in the recipient blocks and embedding them, so that additional arraying and embedding processes are not needed. That is, the mold for the preparation of recipient blocks in accordance with the present invention allows desirable recipient blocks to be prepared in a simple and efficient manner.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A mold for the preparation of recipient blocks, having a certain space at the top, and containing multiple sample-receiving holes in the bottom thereof.

2. The mold according to claim 1, wherein all or part of the perimeter of the mold for the preparation of recipient blocks should be preferably raised in a step-like formation.

3. The mold according to claim 1, wherein the sample-receiving holes are formed as cylindrical holes which are pressed toward the bottom or have rims which project from the bottom.

4. The mold according to claim 3, wherein the mold is provided with at least one opening in the bottom for the material of the recipient block to migrate through the openings when the sample-receiving holes are pressed toward the bottom.

5. The mold according to claim 3, wherein the bottom is compartmented in a grid pattern for the material of the recipient block to migrate through the spaces between grids when rims of the sample-receiving holes project from the bottom.

6. The mold according to claim 1, wherein the mold is made from a material selected from a group consisting of polyethylene, polyurethane, polyimide, polyethylene terephthalate, polymethylmethacrylate, polypropylene, polystyrene, polycarbonate, polyvinyl chloride, polyvinylidene chloride, polyvinyl acetate, polyvinyl alcohol, an acryl resin, a phenyl resin, a urea resin, a silicone resin, an epoxy resin, a melamine resin, polyester, polycarbonate, a fluorine resin, a cellulose resin, and an acetal resin.

7. A method for preparing a tissue microarray block, comprising:
(1) arraying samples in the sample-receiving holes in the mold for the preparation of recipient blocks of claim 1;
(2) placing the mold for the preparation of recipient blocks in a base mold and pushing the samples toward the bottom of the base mold;
(3) filling the base mold with a liquid base material for the recipient block and incubating the liquid base material at a predetermined temperature for a predetermined time period; and
(4) separating the tissue microarray block from the mold for the preparation of recipient blocks, said tissue microarray block being formed as the liquid base material is solidified so that the samples are embedded in a microarray pattern within the solidified material.

8. The method according to claim 7, wherein there should be some spacing between the bottom of the sample-receiving holes in the mold for the preparation of recipient blocks and the bottom of the base mold in step (2).

9. The method according to claim 8, wherein the liquid base material for the recipient block comprises paraffin.

10. The method according to claim 7, wherein the liquid base material is incubated at 45˜60° C. for 10˜60 min.

11. The mold according to claim 2, wherein the sample-receiving holes are formed as cylindrical holes which are pressed toward the bottom or have rims which project from the bottom.
